(19) United States
(12) Patent Application Publication
(10) Pub. No.: US 2012/0120330 A1
(43) Pub. Date: May 17, 2012

(54) STEREOSCOPIC DISPLAY DEVICE AND MANUFACTURING METHOD THEREOF

(76) Inventors: Min-Ta Lai, Taoyuan County (TW); Yao-Li Cheng, Taipei City (TW)

(21) Appl. No.: 13/053,221

(22) Filed: Mar. 22, 2011

(30) Foreign Application Priority Data
Nov. 15, 2010 (TW) 099139165

(51) Int. Cl. G02F 1/1335; H01J 9/00; G02B 27/22

(52) U.S. Cl. 349/15; 445/24

(57) ABSTRACT

A stereoscopic display device includes a reactive mesogen layer disposed inside the stereoscopic display, such that a backlight source has a first polarization state and a second polarization state after passing the reactive mesogen layer. The manufacturing method includes the following steps. First, a liquid crystal layer and a reactive mesogen layer are formed between a first substrate and a second substrate, wherein the first substrate includes at least one first eye image region and a second eye image region. Then, render the liquid crystal layer corresponding to the first eye image region and the second eye image region a first state and a second state, respectively. A first exposure step is performed on the reactive mesogen layer for emitting a first exposure light source passing the liquid crystal layer to induce photopolymerization reactions in the reactive mesogen layer. Subsequently, a backlight source is provided.

### BACKGROUND OF THE INVENTION

1. Field of the Invention

The present invention relates to a stereoscopic display device and a manufacturing method thereof, and more particularly, to a stereoscopic display device and a manufacturing method thereof using a reactive mesogen layer to fabricate a microretarder plate.

2. Description of the Prior Art

Generally, stereoscopic display devices can be classified as: glasses type stereoscopic display devices and autostereoscopic display devices. Among the glasses type stereoscopic display devices, polarized glasses are commonly required. The main operating principle of the glasses type stereoscopic display device is to separately display left eye images and right eye images from a stereoscopic display panel, so that a viewer's left eye and right eye can respectively receive the left eye images and the right eye images by wearing a specific glasses, and therefore to create three-dimensional images.

Please refer to FIG. 1, which schematically illustrates a conventional stereoscopic display device. As shown in FIG. 1, the stereoscopic display device 10 includes a liquid crystal display panel 11 and a microretarder plate 12. Odd-row pixels and even-row pixels located on the liquid crystal display panel 11 can display left eye images L and right eye images R respectively, and the left eye images L and the right eye images R have the same polarization direction substantially parallel to a first polarization direction D1. The microretarder plate 12 includes a plurality of half wavelength retardation regions A and a plurality of zero phase retardation regions B, and the half wavelength retardation regions A and the zero phase retardation regions B are alternately arranged with bar shapes. Accordingly, as shown by the image Fl in FIG. 1, odd-row pixels located on the liquid crystal display panel 11 display images having the first polarization direction D1, and then the first polarization direction D1 of the images will be rotated to a second polarization direction D2 after the images pass the half wavelength retardation regions A; even-row pixels located on the liquid crystal display panel 11 display images having the first polarization direction D1, and then the first polarization direction D1 of the images will be maintained after the images pass the zero phase retardation regions B. When a viewer watches the stereoscopic display device 10 by wearing a pair of polarized glasses 13, the viewer's left eye and right eye can respectively receive the left eye images L, having the first polarization direction D1, and the right eye images R, having the second polarization direction D2. Consequently, three-dimensional images can be perceived by the viewer.

Additionally, the microretarder plate 12 is generally made of a glass substrate having an optical film, and the microretarder plate 12 is bonded to the liquid crystal display panel 11 by performing an adhesion process to constitute the stereoscopic display device 10. In the adhesion process, each half wavelength retardation region A and zero phase retardation region B must be respectively bonded to the corresponding odd-row pixels and even-row pixels located on the liquid crystal display panel 11 in order to achieve the aforementioned three-dimensional visual effect. However, misalignments tend to occur in the adhesion process for bonding the liquid crystal display panel 11 and the microretarder plate 12. Thus, the display performance of the conventional stereoscopic display device 10 is decreased.

### SUMMARY OF THE INVENTION

It is therefore one of the objectives of the present invention to provide a stereoscopic display device and a manufacturing method thereof to resolve the limitation and drawbacks of the conventional stereoscopic display device.

In accordance with a preferred embodiment of the present invention, a manufacturing method of a stereoscopic display device is described as followed. A first substrate is provided, and the first substrate includes at least one first eye image region and at least one second eye image region. A reactive mesogen layer is formed on the first substrate. A second substrate is disposed at one side of the reactive mesogen layer. A liquid crystal layer is formed between the first substrate and the second substrate, and the liquid crystal layer corresponding to the first eye image region has a first state; the liquid crystal layer corresponding to the second eye image region has a second state. A first exposure step is performed on the reactive mesogen layer for emitting a first exposure light source passing the liquid crystal layer to induce photopolymerization reactions in the reactive mesogen layer. A backlight source is provided, the backlight source has a first polarization state after passing the reactive mesogen layer corresponding to the first eye image region, and also the backlight source has a second polarization state after passing the reactive mesogen layer corresponding to the second eye image region. In addition, the first polarization state and the second polarization state are orthogonal to each other.

In accordance with a preferred embodiment of the present invention, a stereoscopic display device includes a first substrate, a second substrate, a liquid crystal layer, a reactive mesogen layer, and a backlight module. The first substrate includes at least one first eye image region and at least one second eye image region. The second substrate faces the first substrate. The liquid crystal layer and the reactive mesogen layer are disposed between the first substrate and the second substrate. The backlight module is disposed at one side of the second substrate to provide a backlight source, and the backlight source has a first polarization state after passing the reactive mesogen layer corresponding to the first eye image region; and also the backlight source has a second polarization state after passing the reactive mesogen layer corresponding to the second eye image region. The first polarization state and the second polarization state are orthogonal to each other.

In accordance with the stereoscopic display device and the manufacturing method of the present invention, the liquid crystal layer and the reactive mesogen layer are formed in the stereoscopic display device. The liquid crystal layer is able to adjust the polarization state of the exposure light source, so that the exposure light source can have different polarization states after passing the liquid crystal layer corresponding to the first eye image regions and the second eye image regions respectively. Thus, the exposure light sources having different polarization states can induce different photopolymerization reactions in the reactive mesogen layer corresponding to the first eye image regions and the second eye image regions respectively. Therefore, the reactive mesogen layer can be functioned as a microretarder plate. As a result, the stereoscopic display device of the present invention can precisely control the polarization states of images displayed from each first eye image region and each second eye image region. Thus, a three-dimensional display performance can be promoted, and also the problem of misalignment occurring in the adhesion process for bonding the liquid crystal display panel and the microretarder plate can be resolved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional stereoscopic display device.

FIG. 2 is a schematic diagram illustrating liquid crystal arrangements of a reactive mesogen material before and after being illuminated by a light source.

FIG. 3 through FIG. 6 are schematic diagrams illustrating a stereoscopic display device and a manufacturing method thereof according to a first preferred embodiment of the present invention.

FIG. 7 through FIG. 9 are schematic diagrams illustrating a stereoscopic display device and a manufacturing method thereof according to a second preferred embodiment of the present invention.

FIG. 10 is a schematic diagram illustrating an arrangement of each first eye image region and each second eye image region according to an embodiment of the present invention.

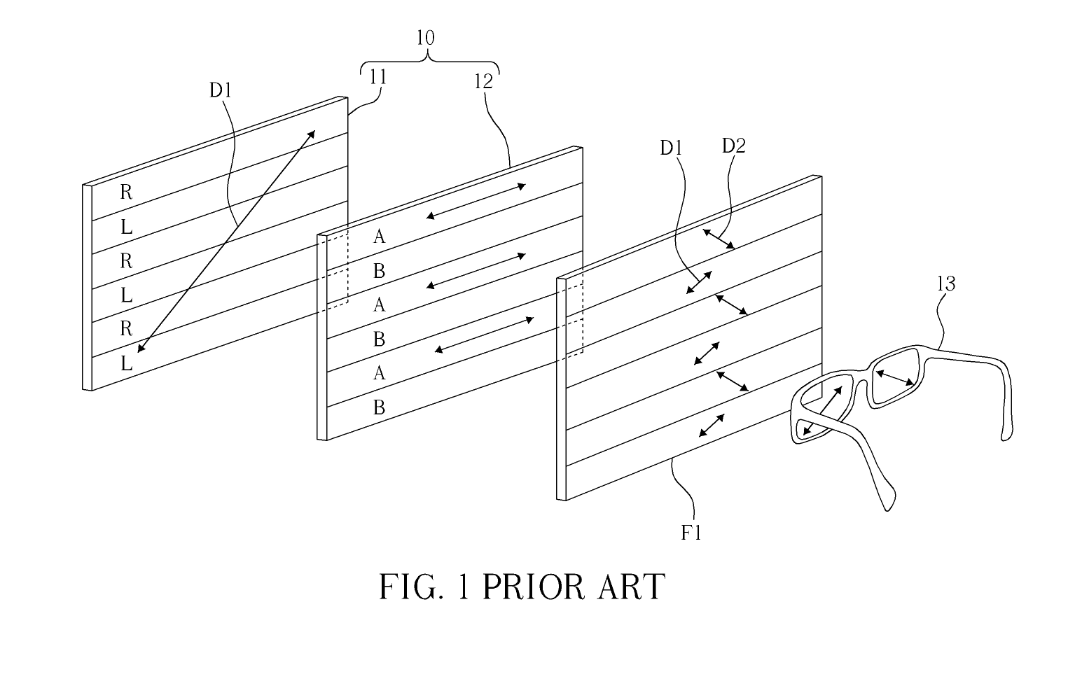

### DETAILED DESCRIPTION

To provide a better understanding of the presented invention for one skilled in the art, preferred embodiments will be detailed as follows. The preferred embodiments of the present invention are illustrated in the accompanying drawings with numbered elements to elaborate the contents and effects to be achieved. Certain terms are used throughout the following descriptions and claims to refer to particular components. As one skilled in the art will appreciate, manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. It is noted that all figures are not to scale.

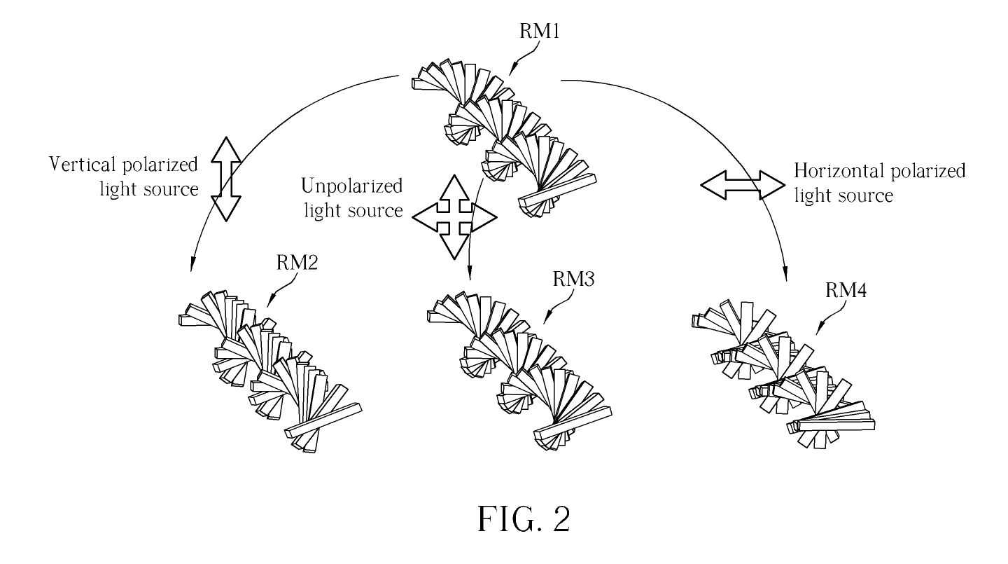

The stereoscopic display device of the present invention uses a reactive mesogen material, and the reactive mesogen material is illuminated by a specific light source. The reactive mesogen material in the present invention will be detailed as followed. Please refer to FIG. 2, which schematically illustrates liquid crystal arrangements of the reactive mesogen material before and after being illuminated by a light source. In the present invention, conformations of the reactive mesogen material can be adjusted by emitting the specific light source. A variety of light sources can be selected for the exposure step according to different reactive mesogen materials. For example, the light source can be an ultraviolet light source. Before the exposure step is taken, the reactive mesogen material can be spirally arranged. In this case, when being illuminated by a light source without a specific polarization direction, the reactive mesogen material will be spirally arranged without a specific rotation direction; when being illuminated by a light source having a specific polarization direction, the liquid crystal arrangement of the reactive mesogen material will be rotated toward the polarization direction of the light source, so that an polarization axis of the reactive mesogen material will be substantially parallel to the polarization direction of the light source. As shown in FIG. 2, when being illuminated by a vertical polarized light source, the reactive mesogen material RM1 will be transformed into the reactive mesogen material RM2 having a optical axis along a vertical direction; when being illuminated by a unpolarized light source, the reactive mesogen material RM1 will be transformed into the reactive mesogen material RM3 spirally arranged without a specific rotation direction; when being illuminated by horizontal polarized light source, the reactive mesogen material RM1 will be transformed into the reactive mesogen material RM4 having a optical axis along a horizontal direction. Accordingly, a half wave plate, a quarter wave plate or a transparent layer without polarization effect can be fabricated by adjusting the polarization direction of the exposure light source and by modifying a film thickness of the reactive mesogen material.

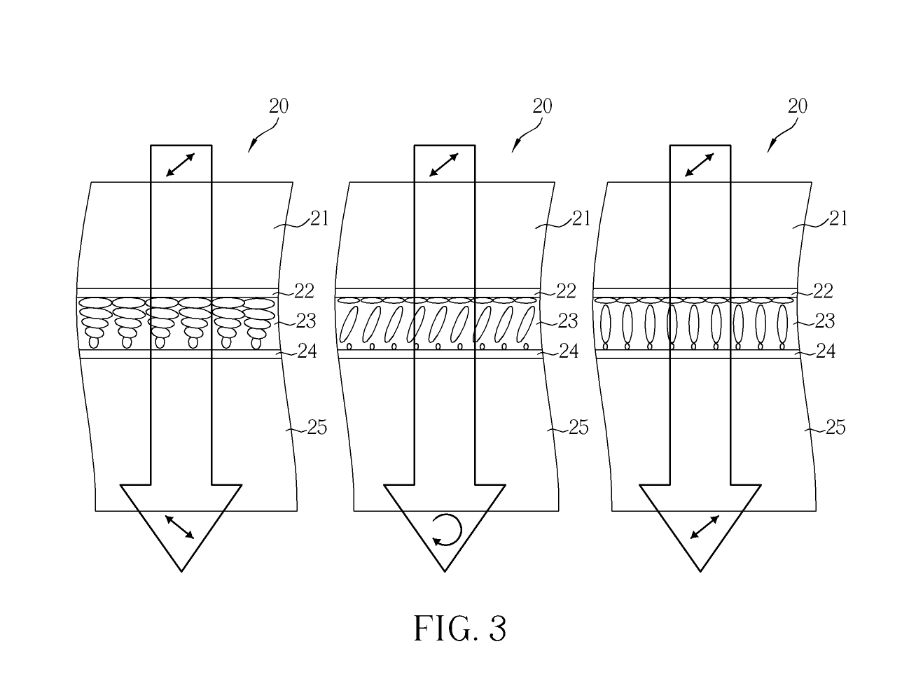

Please refer to FIG. 3 through FIG. 6, which schematically illustrate a stereoscopic display device and a manufacturing method thereof according to a first preferred embodiment of the present invention. As shown in FIG. 3, a liquid crystal panel 20 is utilized for a following selection step of the exposure light source of the reactive mesogen material before the manufacturing method of the stereoscopic display device is taken. The liquid crystal panel 20 mainly includes a first substrate 21, a first electrode layer 22, a liquid crystal layer 23, a second electrode layer 24, and a second substrate 25, but the reactive mesogen material or a polarizer is not included. The liquid crystal panel 20 is illuminated by an exposure light source having a linear polarization state from one side adjacent to the first electrode layer 21 of the liquid crystal panel 20. The polarization state of the exposure light source passing the liquid crystal layer 23 can be altered by adjusting a liquid crystal arrangement in the liquid crystal layer 23 due to a voltage difference formed between the first electrode layer 22 and the second electrode layer 24. As shown in FIG. 3, the liquid crystal layer 23 has different liquid crystal arrangements under different voltage differences. Thus, the original linear polarization state of the exposure light source passing the liquid crystal layer 23 could be rotated by 90 degrees, and also could be transformed into a circular polarization state or maintained as the original polarization direction. For instance, under a specific voltage difference, the original linear polarization state of the exposure light source can be transformed into a circular polarization state, and the exposure light source having the circular polarization state can serve as the exposure light source for the following exposure step. Accordingly, the voltage difference of the liquid layer and the exposure light source can be selected according to the method illustrated in FIG. 3.

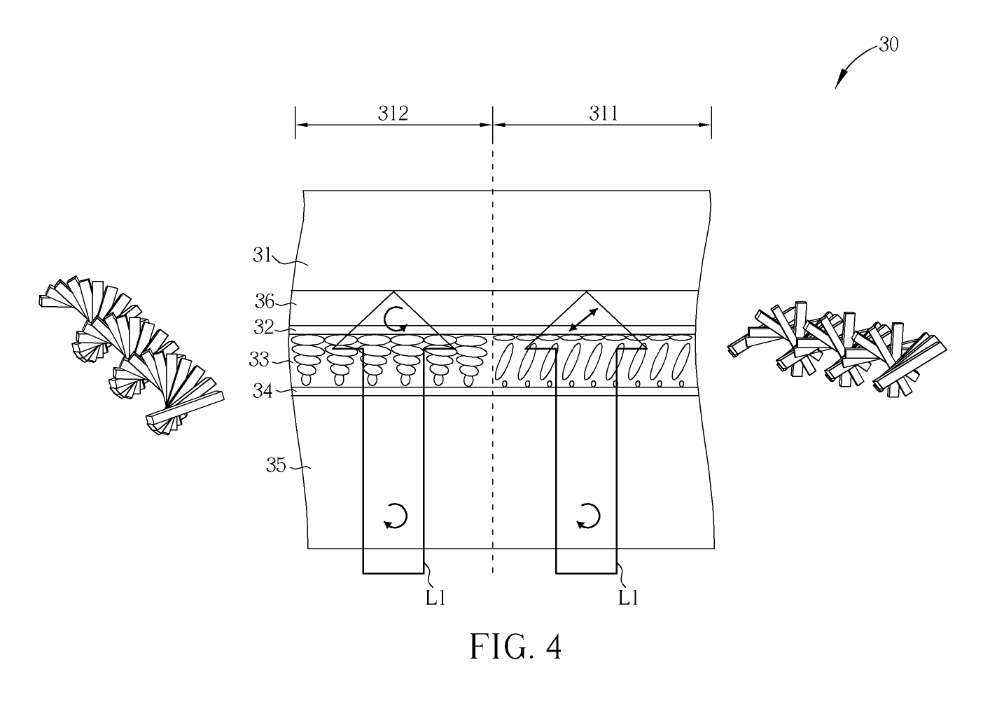

After the exposure light source selecting step illustrated in FIG. 3, the stereoscopic display device 30 according to a first preferred embodiment of the present invention can be fabricated as the following description. As shown in FIG. 4, a first substrate 31 is provided, and the first substrate 31 includes at least one first eye image region 311 and at least one second eye image region 312. For instance, the first eye image region 311 provides images for the left eye of a viewer, and the second eye image region 312 provides images for the right eye of the viewer. A reactive mesogen layer 36 made of the aforementioned reactive mesogen material is formed on the first substrate 31. A second substrate 35 is disposed at one side of the reactive mesogen layer 36. A liquid crystal layer 33 is formed between the first substrate 31 and the second substrate 35. A first electrode layer 32 and a second electrode layer 34 are respectively disposed at two side of the liquid crystal layer 33 to provide a voltage difference for the liquid crystal layer 33, and therefore to alter the liquid crystal arrangement in the liquid crystal layer 33. Accordingly, the liquid crystal layer 33 corresponding to the first eye image region 311 has a first state, and the liquid crystal layer 33 corresponding to the second eye image region 312 has a second state. A first exposure step is performed on the reactive mesogen layer 36 for emitting a first exposure light source L1 passing the liquid crystal layer 33 to induce photopolymerization reactions in the reactive mesogen layer 36. Thus, a half wave plate is formed at the reactive mesogen layer 36 corresponding to the first eye image region 311 by the first exposure light source L1 passing the liquid crystal layer 33 having the first state, and a transparent layer without polarization effect is formed at the reactive mesogen layer 36 corresponding to the second eye image region 312 by the first exposure light source L1 passing the liquid crystal layer 33 having has the second state. Accordingly, the reactive mesogen layer 36 can serve as a microretarder plate including half wavelength retardation regions and zero phase retardation regions.

Specifically, the first exposure light source L1 in the first preferred embodiment can be chosen according to the method illustrated in FIG. 3. According to this preferred embodiment, for example, the first exposure light source L1 has a circular polarization state before entering the liquid crystal layer 33 for example, but not limited thereto. The first exposure light source L1 also can have other polarization states. Moreover, the liquid crystal layer 33 has the first state and the second state by providing a first voltage difference and a second voltage difference for the liquid crystal layer 33 corresponding to the first eye image region 311 and the second eye image region 312 respectively. As shown in FIG. 4, the liquid crystal layer 33 corresponding to the first eye image region 311 has the first state, so that a right-handed circular polarization state of the first exposure light source L1 can be transformed into a linear polarization state. Afterward, the first exposure light source L1 having the linear polarization state is utilized to illuminate the reactive mesogen layer 36, such that the polarization axis of the reactive mesogen layer 36 corresponding to the first eye image region 311 is substantially parallel to a polarization direction of the first exposure light source L1 having the linear polarization state. Also, as shown in FIG. 4, the liquid crystal layer 33 corresponding to the second eye image region 312 has the second state, so that the right-handed circular polarization state of the first exposure light source L1 can be transformed into a left-handed circular polarization state. Afterward, the first exposure light source L1 having the left-handed circular polarization state is utilized to illuminate the reactive mesogen layer 36, such that reactive mesogen layer 36 corresponding to the second eye image region 312 is spirally arranged without a specific rotation direction.

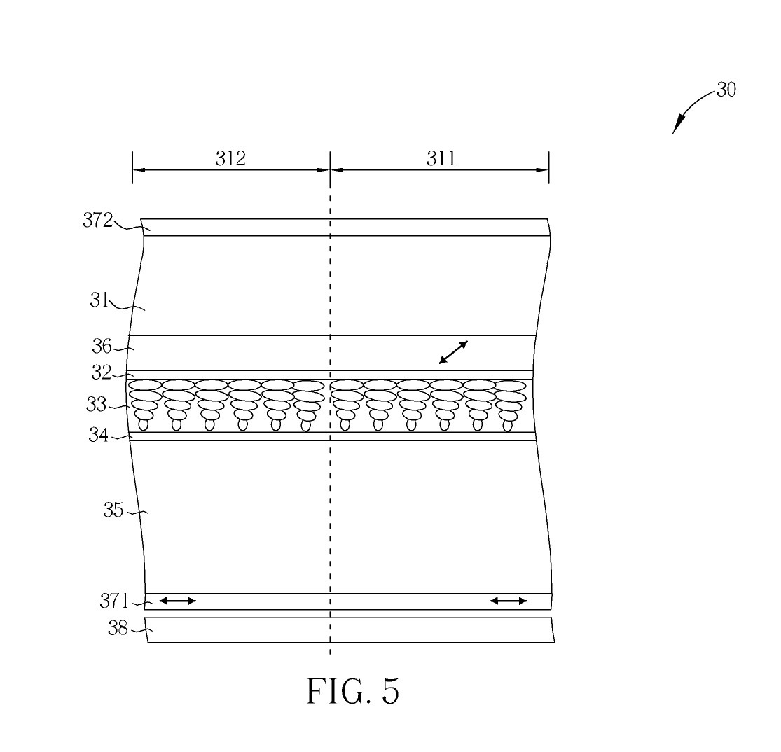

As shown in FIG. 5, after the first exposure step, the manufacturing method according to the first preferred embodiment further includes forming a polarizer 371 above a surface of a backlight module 38 facing the second substrate 35. The polarizer 371 having a polarization axis along a horizontal direction (as shown in FIG. 5) permits light sources having a polarization direction parallel to the polarization axis to pass, and blocks light sources having a polarization direction perpendicular to the polarization axis. Additionally, the backlight module 38 is disposed at one side of the second substrate 35 to provide a backlight source. The backlight source has a first polarization state after passing the reactive mesogen layer 36 corresponding to the first eye image region 311, and has a second polarization state after passing the reactive mesogen layer 36 corresponding to the second eye image region 312. In addition, the first polarization state and the second polarization state are orthogonal to each other. In addition, in the present invention, a quarter wave plate 372 also can be selectively disposed at one side of the liquid crystal layer 33 facing the first substrate 31.

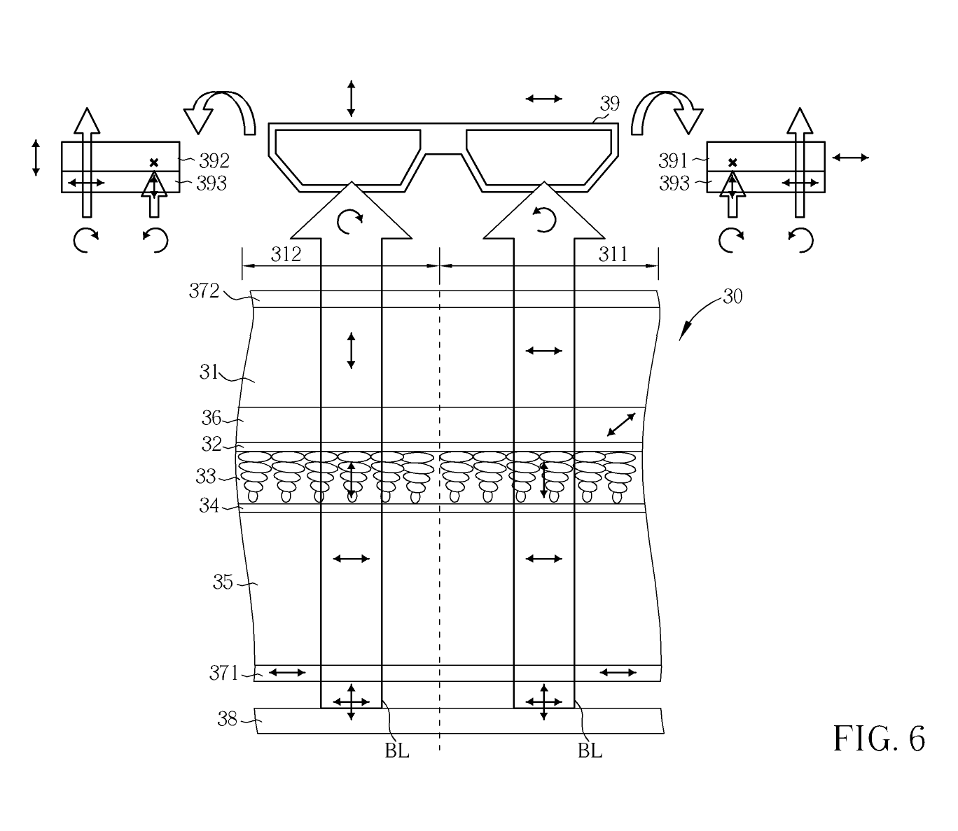

As shown in FIG. 6, the present invention further includes a pair of polarized glasses 39 having a first polarized lens 391 and a second polarized lens 392. The first polarized lens 391 permits the backlight source having the first polarization state to pass, and blocks the backlight source having the second polarization state; the second polarized lens 392 permits the backlight source having the second polarization state to pass, and blocks the backlight source having the first polarization state. Moreover, when the quarter wave plate 372 is disposed on the first substrate 31 of the stereoscopic display device 30 according to the first preferred embodiment, a quarter wave plate 393 will be required to be disposed on the first polarized lens 391 and the second polarized lens 392 respectively. Thus, the stereoscopic display device 30 according to the first preferred embodiment of the present invention is accomplished.

The stereoscopic display device 30 having the quarter wave plate 372 is taken for an example in the following description to elaborate an operating principle of the present invention. As shown in FIG. 6, the backlight source BL provided by the backlight module 38 has the first polarization state with a horizontal polarization direction (as shown in FIG. 6) after passing the polarizer 371, and then the backlight source has the second polarization state with a vertical polarization direction (as shown in FIG. 6) after passing the liquid crystal layer 33. Afterward, the backlight source BL enters the reactive mesogen layer 36 corresponding to the first eye image region 311 and the second eye image region 312 respectively. In this preferred embodiment, the reactive mesogen layer 36 corresponding to the first eye image region 311 serves as the half wave plate, and the backlight source has the vertical polarization direction (the second polarization direction) before entering the reactive mesogen layer 36. Therefore, the polarization axis of the half wave plate and a horizontal direction have an included angle being set as about 45 degrees, that also means the polarization axis of the half wave plate and the polarization direction of the second polarization state have an included angle of about 45 degrees. Accordingly, the polarization direction of the backlight source can is rotated by 2×45 degrees (90 degrees), and thus the original second polarization state will be transformed into the first polarization state (the vertical polarization direction is rotated to the horizontal polarization direction as shown in FIG. 6). In addition, since the reactive mesogen layer 36 corresponding to the second eye image region 312 is a transparent layer without polarization effect, the backlight source BL can maintain the second polarization state. Then, the quarter wave plates 393 on the polarized glasses 39 will transform the left-handed circular polarization state of the backlight source BL into the first polarization state, and transform the right-handed circular polarization state of the backlight source BL into the second polarization state. Afterward, the first polarized lens 391 permits the backlight source BL having the first polarization state to pass, and blocks the backlight source BL having the second polarization state; the second polarized lens 392 permits the backlight source BL having the second polarization state to pass, and blocks the backlight source BL having the first polarization state. Accordingly, by wearing the polarized glasses 39, a viewer's left eye and right eye can respectively receive the left eye images 311 and the right eye images 312, and therefore three-dimensional images can be perceived by the viewer.

In this preferred embodiment, the second polarization state of the backlight source BL passing the liquid crystal layer 33 is not limited to the vertical polarization direction, but can be changed according to different designs. For instance, the second polarization state can be a non-vertical polarization direction by utilizing different alignment techniques to change the different phase retardation effect of the liquid crystal layer 33. On condition that the second polarization state is set as a non-vertical polarization direction, a polarization direction of the backlight source passing the liquid crystal layer, an optical axis, a polarization direction of the backlight source passing the half wave plate, and a horizontal direction are related to as following description. When an included angle of the polarization direction of the backlight source passing the half wave plate and the horizontal direction is set as 90 degrees, the polarization direction of the backlight source passing the liquid crystal layer and the horizontal direction have an included angle θ, the optical axis of the half wave plate and the polarization direction of the backlight source passing the liquid crystal layer have an included angle α, and the optical axis of the half wave plate and the horizontal direction have an included angle ψ. The aforementioned relation includes: 0°<θ<90°, α=(90°−θ)/2, and ψ=(90°−θ)/2+θ.

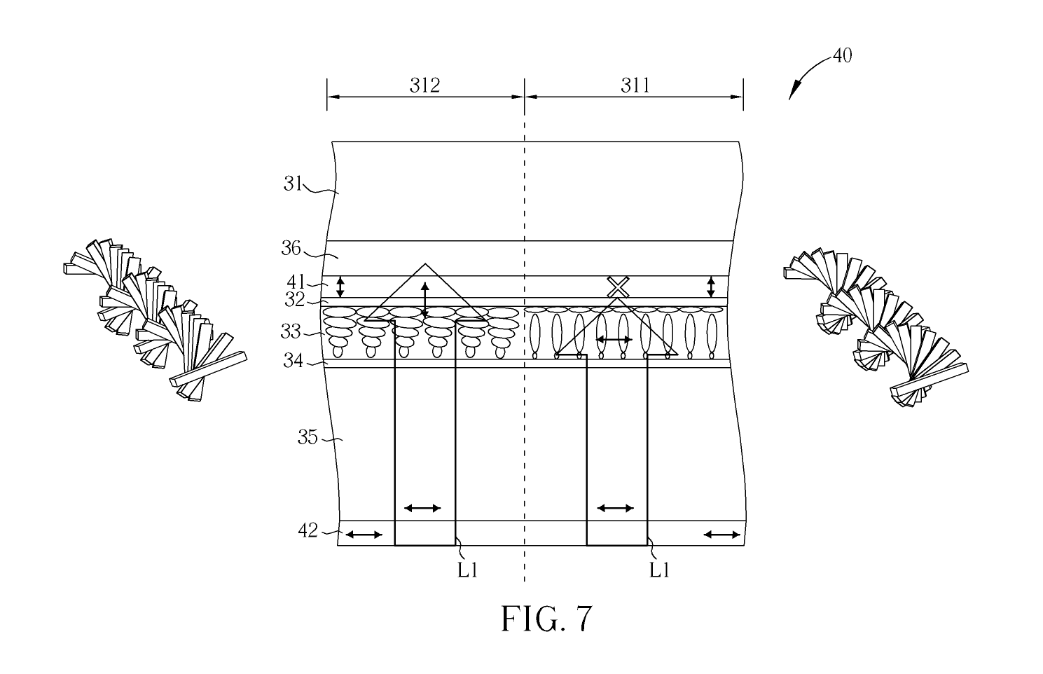

Please refer to FIG. 7 through FIG. 9, which schematically illustrate a stereoscopic display device and a manufacturing method thereof according to a second preferred embodiment of the present invention. For the sake of clear comparison between different embodiments, identical components are denoted by identical numerals. As shown in FIG. 7, according to the second preferred embodiment, the reactive mesogen layer 36 is also formed on the first substrate 31, and than an extra step is further included for forming a first polarizer 41 on the reactive mesogen layer 36 and a second polarizer 42 on the second substrate 35−before the first exposure step as compared with the first embodiment. A polarization axis of the first polarizer 41 is substantially perpendicular to a polarization axis of the second polarizer 42. The reactive mesogen layer 36 is disposed between the first substrate 31 and the first polarizer 41. Accordingly, the liquid crystal layer 33 corresponding to the first eye image region 311 has a first state, and the liquid crystal layer 33 corresponding to the second eye image region 312 has a second state. A first exposure step is performed on the reactive mesogen layer 36 for emitting a first exposure light source L1 passing the liquid crystal layer 33 to induce photopolymerization reactions in the reactive mesogen layer 36.

In accordance with the second preferred embodiment, as shown in FIG. 7, the first exposure light source L1 has a first polarization state with a horizontal polarization direction (as shown in FIG. 7) after passing the second polarizer 42. Then, the liquid crystal arrangement in liquid crystal layer 33 can be altered by applying a voltage difference between the first electrode layer 32 and the second electrode layer 34. Thus, the first polarization state of the first exposure light source L1 can be maintained after the first exposure light source L1 passes the liquid crystal layer 33 corresponding to the first eye image region 311, and the first polarization state of the first exposure light source L1 can be rotated to the second polarization state with a vertical polarization direction (as shown in FIG. 7) after the first exposure light source L1 passes the liquid crystal layer 33 corresponding to the second eye image region 312. Therefore, the first exposure light source L1 can not pass the first polarizer 41 after passing the liquid crystal layer 33 corresponding to the first eye image region 311 and having the first state, and the first exposure light source L1 can pass the first polarizer 41 after passing the liquid crystal layer 33 corresponding to the second eye image region 312 and having the second state to illuminate the reactive mesogen layer 36 corresponding to the second eye image region 312. The reactive mesogen layer 36 corresponding to the first eye image region 311 is not illuminated by the first exposure light source L1, so that the liquid crystal arrangement in the reactive mesogen layer 36 is unaffected; the reactive mesogen layer 36 corresponding to the second eye image region 312 is illuminated by the first exposure light source L1 and thus is photopolymerized, so that the optical axis of the reactive mesogen layer 36 is substantially parallel to the polarization axis (the vertical polarization direction as shown in FIG. 7) of the first polarizer 41.

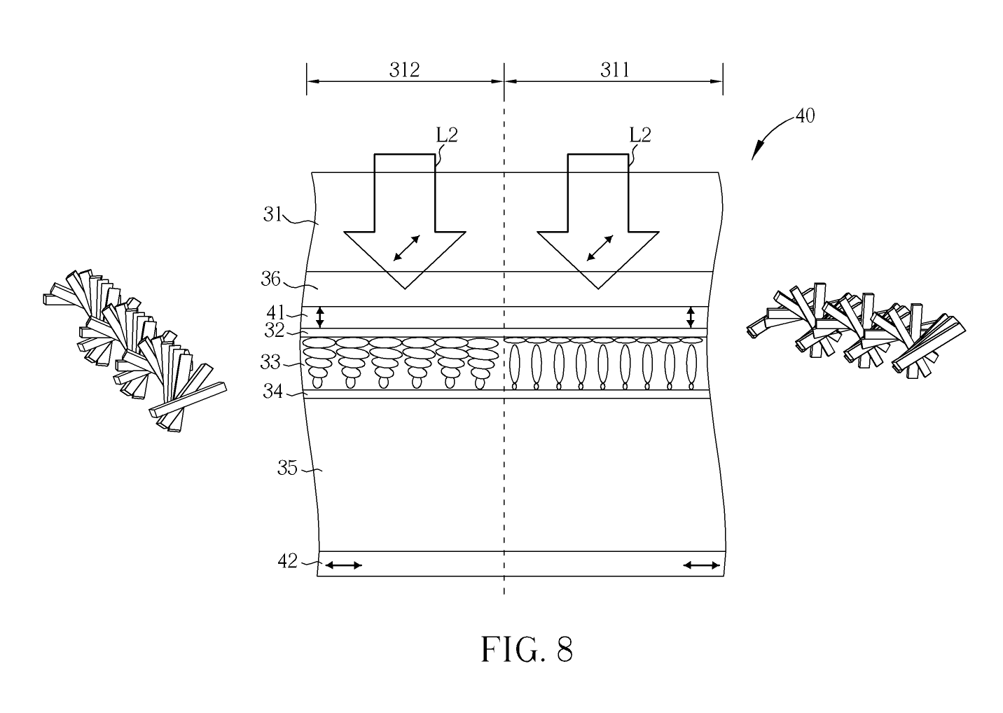

As shown in FIG. 8, after the first exposure step, a second exposure step is further included in the second preferred embodiment. The second exposure step is performed on the reactive mesogen layer 36 for emitting a second exposure light source L2 passing the first substrate 31 to induce photopolymerization reactions in the reactive mesogen layer 36. More specifically, an emitting path of the second exposure light source L2 is from the first substrate 31 to the second substrate 35, and an emitting path of the first exposure light source L1 is from the second substrate 35 to the first substrate 31, in other words, the second exposure light source L2 is emitted with a direction opposite to the first exposure light source L1 is. In this preferred embodiment, the second exposure light source L2 is linear polarized, and an included angle between the linear polarization axis of the second exposure light source L2 and the polarization axis of the first polarizer 41 (the vertical direction shown in FIG. 8) is about 45 degrees. Accordingly, a half wave plate is formed at the reactive mesogen layer 36 corresponding to the first eye image region 311 by the second exposure light source L2, and an optical axis of the half wave plate and the polarization axis of the first polarizer 41 have an included angle of 45 degrees. Moreover, the reactive mesogen layer 36 corresponding to the second eye image region 312 has been photopolymerized in the first exposure step, and thus is unaffected by the second exposure step, so that the liquid crystal arrangement in the reactive mesogen layer 36 is maintained as the vertical polarization direction.

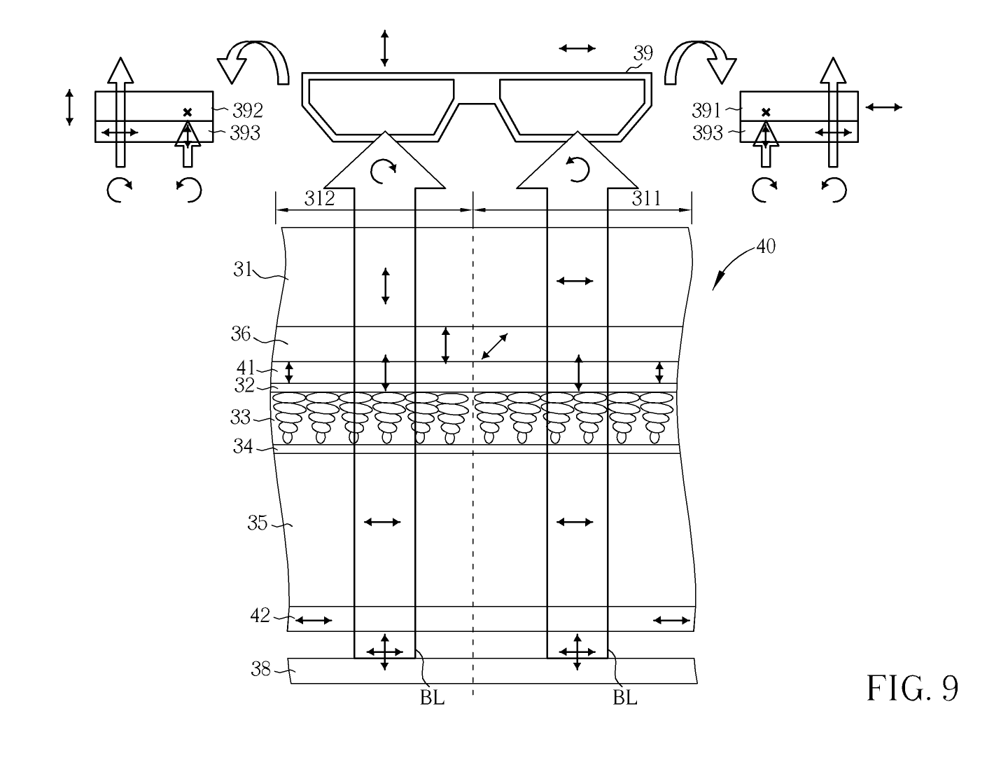

As shown in FIG. 9, according to the second preferred embodiment, the backlight module 38 is disposed at one side of the second substrate 35, and a quarter wave plate 372 can be selectively disposed on one side of the first substrate 31 opposite to the liquid crystal layer 33. Also, a pair of polarized glass 39 having the first polarized lens 391 and the second polarized lens 392 is required. When the quarter wave plate 372 is disposed on the first substrate 31 of the stereoscopic display device 40, another quarter wave plate 393 will be required to be disposed on the first polarized lens 391 and the second polarized lens 392 respectively. Thus, the stereoscopic display device 40 according to the second preferred embodiment of the present invention is accomplished. Moreover, an operating principle of the stereoscopic display device 40 according to the second preferred embodiment is substantially the same as that of the stereoscopic display device 30 according to the first preferred embodiment, and thus not redundantly described.

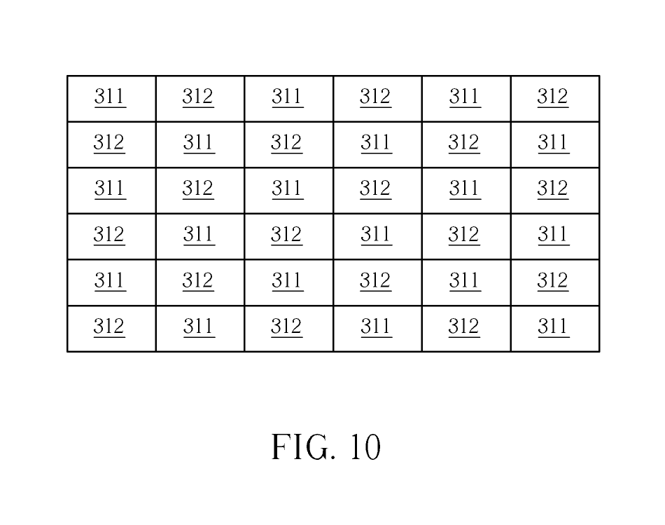

For the sake of clear illustration, only a first eye image region 311 and a second eye image region 312 are shown in the aforementioned figures, but not limited thereto. A plurality of the first eye image regions 311 and a plurality of the second eye image regions 312 also can be included in the present invention. Moreover, an arrangement of each first eye image region 311 and each second eye image region 312 is not limited. Please refer to FIG. 10, which schematically illustrates the arrangement of each first eye image region 311 and each second eye image region 312 according to an embodiment of the present invention. As shown in FIG. 10, the first eye image regions 311 and the second eye image regions 312 are arranged in a matrix. Each first eye image region 311 is adjacent to two of the second eye image regions 312 along a column direction and a row direction respectively, and each second eye image region 312 is adjacent to two of the first eye image regions 311 along the column direction and the row direction respectively. In other words, the first eye image regions 311 and the second eye image regions 312 are alternately arranged along each column, and also alternately arranged along each row. According to this embodiment, the first eye image regions 311 provide the left eye images, and the second eye image regions 312 provide the right eye images, but no limited thereto. Compared to the microretarder plate with bar-shaped patterns, the arrangement of each first eye image region 311 and each second eye image region 312 according to this embodiment is beneficial for reducing unnecessary stripe visual phenomenon and promoting the display performance.

To sum up, according to the stereoscopic display device and the manufacturing method of the present invention, the liquid crystal layer and the reactive mesogen layer are formed in the stereoscopic display device. The liquid crystal layer is able to adjust the polarization state of the exposure light source, so that the exposure light source has different polarization states after passing the liquid crystal layer corresponding to the first eye image regions and the second eye image regions respectively. Thus, the exposure light sources having different polarization states the can induce different photopolymerization reactions in the reactive mesogen layer corresponding to the first eye image regions and the second eye image regions respectively. Therefore, the reactive mesogen layer can be functioned as a microretarder plate. As a result, the stereoscopic display device of the present invention can precisely control the polarization states of images displayed from each first eye image region and each second eye image region. Thus, the three-dimensional display performance can be promoted, and also the problem of misalignment occurring in the adhesion process for bonding the liquid crystal display panel and the microretarder plate can be resolved. Moreover, the stereoscopic display device and the manufacturing method of the present invention also can applied for field sequential color stereoscopic display devices, RGB projection stereoscopic display devices, and other stereoscopic display devices.

Those skilled in the art will readily observe that numerous modifications and alterations of the device and method may be made while retaining the teachings of the invention.

What is claimed is:

1. A manufacturing method of a stereoscopic display device, comprising:
providing a first substrate, wherein the first substrate comprises at least one first eye image region and at least one second eye image region;
forming a reactive mesogen layer on the first substrate;
disposing a second substrate at one side of the reactive mesogen layer, and forming a liquid crystal layer between the first substrate and the second substrate;
rendering the liquid crystal layer corresponding to the first eye image region a first state, rendering the liquid crystal layer corresponding to the second eye image region a second state, and performing a first exposure step on the reactive mesogen layer, wherein a first exposure light source passing the liquid crystal layer is utilized to induce photopolymerization reactions in the reactive mesogen layer; and
providing a backlight source, wherein the backlight source has a first polarization state after passing the reactive mesogen layer corresponding to the first eye image region, and the backlight source has a second polarization state after passing the reactive mesogen layer corresponding to the second eye image region, wherein the first polarization state and the second polarization state are orthogonal to each other.

2. The manufacturing method of the stereoscopic display device according to claim 1, wherein the step for rendering the liquid crystal layer respectively have the first state and the second state further comprises:
providing a first voltage difference to the liquid crystal layer corresponding to the first eye image region, so that the liquid crystal layer corresponding to the first eye image region have the first state; and
providing a second voltage difference to the liquid crystal layer corresponding to the second eye image region, so that the liquid crystal layer corresponding to the second eye image region have a second state.

3. The manufacturing method of the stereoscopic display device according to claim 1, wherein the first exposure light source after passing the liquid crystal layer having the second state renders the reactive mesogen layer corresponding to the second eye image region a transparent layer without polarization effect, the first exposure light source after passing the liquid crystal layer having the first state renders the reactive mesogen layer corresponding to the first eye image region a half wave plate, a polarization direction of the backlight source passing the liquid crystal layer and a horizontal direction have an included angle θ, an optical axis of the half wave plate and the polarization direction of the backlight source passing the liquid crystal layer have an included angle α, the optical axis of the half wave plate and the horizontal direction have an included angle ψ, wherein when an included angle of a polarization direction of the backlight source passing the half wave plate and the horizontal direction is 90 degrees, 0°<θ<90°, α=(90°−θ)/2, and ψ=(90°−θ)/2+θ.

4. The manufacturing method of the stereoscopic display device according to claim 1, wherein after the first exposure step, the manufacturing method further comprises a step of forming a polarizer on the second substrate.

5. The manufacturing method of the stereoscopic display device according to claim 1, wherein before the first exposure step, the manufacturing method further comprises a step of forming a first polarizer on the reactive mesogen layer, and forming a second polarizer on the second substrate, wherein a polarization axis of the first polarizer is substantially perpendicular to a polarization axis of the second polarizer, and the reactive mesogen layer is disposed between the first substrate and the first polarizer.

6. The manufacturing method of the stereoscopic display device according to claim 5, wherein the first exposure light source is unable to pass the first polarizer after passing the liquid crystal layer having the first state, and the first exposure light source further passes the first polarizer after passing the liquid crystal layer having the second state to illuminate the reactive mesogen layer corresponding to the second eye image region.

7. The manufacturing method of the stereoscopic display device according to claim 6, wherein after the first exposure step, the manufacturing method further comprises performing a second exposure step, wherein the second exposure step is performed for emitting a second exposure light source passing the liquid crystal layer to induce photopolymerization reactions in the reactive mesogen layer, and the second exposure light source renders the reactive mesogen layer corresponding to the first eye image region a half wave plate, and an optical axis of the half wave plate and a polarization axis of the first polarizer have an included angle of about 45 degrees.

8. A stereoscopic display device, comprising:
a first substrate, wherein the first substrate comprises at least one first eye image region and at least one second eye image region;
a second substrate, facing the first substrate;
a liquid crystal layer, disposed between the first substrate and the second substrate;
a reactive mesogen layer, disposed between the first substrate and the second substrate; and
a backlight module, disposed at one side of the second substrate for providing a backlight source, wherein the backlight source has a first polarization state after passing the reactive mesogen layer corresponding to the first eye image region, and the backlight source has a second polarization state after passing the reactive mesogen layer corresponding to the second eye image region, wherein the first polarization state and the second polarization state are orthogonal to each other.

9. The stereoscopic display device according to claim 8, further comprising a pair of polarized glasses, the polarized glasses having a first polarized lens and a second polarized lens, wherein the first polarized lens permits the backlight source having the first polarization state to pass, and blocks the backlight source having the second polarization state; the second polarized lens permits the backlight source having the second polarization state to pass, and blocks the backlight source having the first polarization state.

10. The stereoscopic display device according to claim 9, further comprising a plurality of quarter wave plates, disposed at one side of the liquid crystal layer corresponding to the first substrate, on the first polarized lens, and on the second polarized lens, respectively.
